(19) United States
(12) Patent Application Publication
(10) Pub. No.: US 2011/0027420 A1
(43) Pub. Date: Feb. 3, 2011

(54) MOISTURE MIGRATION REDUCTION LAYER FOR A FOOD PRODUCT

(76) Inventor: Haile Mehansho, Hamilton, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/533,047

(22) Filed: Jul. 31, 2009

(51) Int. Cl. A23L 1/30; A23L 1/00; A23L 1/302; A23L 1/304

(52) U.S. Cl. 426/61; 426/103; 426/72; 426/74

(57) ABSTRACT

A moisture migration reduction layer suitable for use with a food product to reduce moisture migration into, out of or within the food product. Further, a moisture migration reduction layer for a food product which attenuates loss of viability of an active ingredient such as a probiotic micro-organism.

### FIELD OF THE INVENTION

The present invention relates generally to a moisture migration reduction layer suitable for use with a food product. The present invention relates to a moisture migration reduction layer for a food product which reduces moisture migration into, within and/or out of the moisture migration reduction layer and/or the food product. The present invention relates to a moisture migration reduction layer for a food product which attenuates loss of viability of an active ingredient such as a probiotic micro-organism.

### BACKGROUND OF THE INVENTION

Many food products for humans and animals, such as companion animals, have as their basic ingredients protein, fat, and carbohydrate. It is also desirable to incorporate into the food product an active ingredient for the therapeutic benefit of the human or animal. For example, there is considerable interest in incorporating an active ingredient such as a probiotic micro-organism into food products. Probiotic micro-organisms are micro-organisms which can beneficially affect a host by improving the host's gastrointestinal tract microbial balance. Probiotic micro-organisms can inhibit the growth of pathogenic bacteria, treat and prevent conditions caused by pathogenic bacteria, and it is believed that probiotic micro-organisms can activate the immune function of the host. There is, therefore, particular interest in incorporating probiotic micro-organisms into a food product.

When incorporating a probiotic micro-organism, or any other active ingredient, into a food product there are two main concerns: the resultant food product must be palatable to the consumer of the food product and the active ingredient must remain viable during manufacture, storage and transport of the food product. Manufacture of a food product exposes the active ingredient to stresses such as temperature, moisture level, and elevated shear rates. The manufacturing stresses can be present at any point in time during manufacture of the food product such as, but not limited to, mixing, conditioning, cooking, extruding, baking, drying, and packaging. These various stresses may prompt the manufacturer of the food product to over-dose the active ingredient during manufacture of the food product in an attempt to compensate for any degradation of the active ingredient. Storage and transport of the resultant food product, however, also expose the food product and active ingredient to stresses such as temperature, humidity and moisture level. These various stresses result in degradation of the active ingredient and shortening of the shelf life of the food product.

Moisture migration into, out of and/or within food products can compromise the quality, taste and organoleptic properties of the food product. Additionally, moisture migration may cause chemical and enzymatic reactions within the food product. Moisture migration, therefore, can cause negative changes in the taste, texture, smell and nutritional value of the food product. In the event the food product is intended to deliver a specific active ingredient to the consumer of the food product, moisture migration into, out of and/or within the food product can have an especially deleterious effect on the active ingredient. The negative changes due to moisture migration into, out of and/or within the food product can, in turn, impact the shelf life of the food product. Shelf life is generally regarded as the time that elapses before stored food products become unsuitable for use due to degradation. The moisture level of many food products, therefore, needs to be maintained in order for the food product to maintain quality, taste, and its organoleptic properties.

It would be desirable to provide a food product with a stable active ingredient. It would be desirable to provide a moisture migration reduction layer for a food product that reduces moisture migration. It would be desirable to provide a moisture migration reduction layer for a food product that reduces degradation of an active ingredient. It would be desirable to provide a moisture migration reduction layer for a food product that attenuates loss of viability of a probiotic micro-organism.

### SUMMARY OF THE INVENTION

A food product comprising a core comprising a macronutrient selected from the group consisting of a first protein source, a fat source, a carbohydrate source, and combinations thereof, and a moisture migration reduction layer, the moisture migration reduction layer comprising a high melting point lipid, a metal oxide, an active ingredient, and from about 0. 1 % to about 50% of a second protein source, by weight of the moisture migration reduction layer.

A food product comprising a core comprising a macronutrient selected from the group consisting of a protein source, a fat source, a carbohydrate source, and combinations thereof, and a moisture migration reduction layer, the moisture migration reduction layer comprising a high melting point lipid, a metal oxide, and an active ingredient, wherein the ratio of the high melting point lipid to the metal oxide is from about 4:1 to about 50:1.

A moisture migration reduction layer comprising a high melting point lipid, a metal oxide, and a probiotic micro-organism, wherein the ratio of the high melting point lipid to the metal oxide is from about 4:1 to about 50:1.

### DETAILED DESCRIPTION OF THE INVENTION

Definitions:

As used herein, the term “active ingredient” refers to a food product ingredient or biological material that provides therapeutic benefit to a human or animal, such as a companion animal, by interacting with or having an effect on cell tissue in the body of the human or the animal. Non-limiting examples of an active ingredient include minerals, vitamins, amino acids, carotenoids, antioxidants, probiotic micro-organisms, botanical extracts and omega-3 fatty acids. Due to stresses encountered during manufacture, storage and/or transport of the food product the active ingredient can be difficult to incorporate into or maintain in the food product.

As used herein, the term “companion animal” refers to any animal for which an owner, breeder or caregiver controls the feeding habits. In an embodiment, a companion animal is an animal selected from the group consisting of dog, cat, rabbit, hamster, gerbil, ferret, and guinea pig. In an embodiment, a companion animal is a dog or a cat.

As used herein, the term “core” refers to the base nutritional matrix of food product ingredients in a food product as desired by one of ordinary skill in the art. For example, a core that is intended for consumption by an animal, such as a companion animal, is an extruded kibble. As another example, a core that is intended for consumption by a human is a dried ready-to-eat cereal in the in shape of a puffed crisp. In an embodiment, the core comprises a macronutrient selected from the group consisting of a protein source, a fat source, a carbohydrate source and combinations thereof. In an embodiment, the core comprises additional food product ingredients as desired by one of ordinary skill in the art such as, for example, a dietary fiber source, a starch source, an active ingredient and combinations thereof. The core can be shaped into any desired shape or size for consumption.

As used herein, the term “food product” refers to a composition safe for consumption by a human or animal, such as a companion animal, such as, for example, a diet (e.g., dried ready-to-eat cereal for a human, kibbles for a companion animal, etc.), supplement, cookie, biscuit or treat. The food product comprises a core. In an embodiment, the food product comprises a core and a layer. In such an embodiment, the layer is a moisture migration reduction layer as described hereinbelow. In an embodiment, the food product comprises a core and at least two layers. In such an embodiment, at least one layer is a moisture migration reduction layer. In such an embodiment, the additional layer(s) can be a moisture migration layer(s) or supplemental food product ingredient layer(s). A supplemental food product ingredient layer is described hereinbelow. In an embodiment, the food product is nutritionally balanced. As used herein, the term “nutritionally balanced” means that the food product comprises the known required nutrients to sustain life in proper amounts and proportion based on recommendations of recognized authorities in the field of nutrition. In an embodiment, the food product has a moisture content of less than about 15% by weight of the food product. The food product comprises attributes that are physical, organoleptical and combinations thereof. Such attributes can be any attribute that can affect any of the senses of the human or companion animal such as sight, touch, taste, smell and sound. Attributes of a food product include, but are not limited to, aroma, flavor, hardness, chewiness, shape, texture, color, size, pH and moisture level.

As used herein, the term “layer” refers to an edible material covering a surface such as, for example, the surface of a food product core or the surface of another layer. It should be realized that the food product comprises as many layers as desired by one of ordinary skill in the art. In an embodiment, the food product comprises a core and a layer. In such an embodiment, the layer is a moisture migration reduction layer. As used herein, the term “moisture migration reduction layer” refers to a layer that reduces moisture migration into, within and/or out of the moisture migration reduction layer and/or the food product. In such an embodiment, the moisture migration reduction layer is, therefore, applied to an external surface of the core of the food product and, for example, reduces moisture migration between the food product and the environment. An example of such an embodiment is a food product comprising a core of an extruded kibble and a moisture migration reduction layer applied to the surface of the extruded kibble. In such an example, it should be realized that the core may also comprise an active ingredient and the active ingredient of the core may be the same as or different than the active ingredient of the moisture migration reduction layer. In another example, the food product comprises a core of an extruded kibble and a layer applied to the surface of the extruded kibble. In such an example the core comprises an active ingredient and the layer comprises a high melting point lipid and a metal oxide. In an embodiment, the food product comprises a core and In an embodiment, the food product comprises a core at least two layers. In such an embodiment, one of the layers is a moisture migration reduction layer. In such an embodiment, the additional layer(s) can be a second moisture migration reduction layer(s) or can be a supplemental food product ingredient layer(s). As used herein, the term “supplemental food product ingredient layer” refers to a layer comprising at least one food product ingredient which is supplemental to the core of the food product. Non-limiting examples of food product ingredients include a protein source, a fat source, a carbohydrate source, a starch source, a dietary fiber source, an active ingredient, and combinations thereof. In an example, the food product comprises a core of an extruded kibble and two layers in which one layer is a moisture migration reduction layer and the second layer is a supplemental food product ingredient layer comprising an active ingredient. In such an example, the supplemental food product ingredient layer is between the core and the moisture migration reduction layer and the active ingredient of the supplemental food product ingredient layer may be the same as or different than the active ingredient of the moisture migration reduction layer. In another example, the food product comprises a core and two layers in which one layer is a supplemental food product ingredient layer comprising an active ingredient and the second layer comprises a high melting point lipid and a metal oxide. In such an example the supplemental active ingredient layer is between the core and the layer comprising the high melting point lipid and the metal oxide.

The supplemental food product ingredient layer comprises at least one food product ingredient selected from the group consisting of a food product ingredient which is the same as a food product ingredient of the core, a food product ingredient which is of the same category as a food product ingredient of the core, a food product ingredient which is not already within the core, and combinations thereof. In an embodiment in which the food product ingredient of the supplemental food product ingredient layer is the same as a food product ingredient of the core, the food product ingredient of the supplemental food product ingredient layer increases the total weight percent of the referred to food product ingredient by weight of the food product. An example of such an embodiment is a core comprising 10% of chicken meal and a supplemental food product ingredient layer comprising 10% of chicken meal for a total of 20% of chicken meal by weight of the food product. An example in which the food product ingredient of the supplemental food product ingredient layer is of the same category as a food product ingredient of the core is a core comprising an animal based protein and a supplemental food product ingredient layer comprising a plant based protein. In such an example, the core and the supplemental food product ingredient layer both contain a food product ingredient from a protein source. An example in which the food product ingredient of the supplemental food product ingredient layer is not already within the core of the food product is a supplemental food product ingredient layer comprising a palatant that is not within the core of the food product. Non-limiting locations wherein a moisture migration reduction layer of food products with two or more layers can be located include between the core and a supplemental food product ingredient layer, between the core and another moisture migration reduction layer, between a supplemental food product ingredient layer and another moisture migration reduction layer, between two supplemental food product ingredient layers, and on the external surface of the food product. The moisture migration reduction layer, therefore, reduces moisture migration between locations of the food product (e.g., the core and/or the supplement food product ingredient layer(s)) and/or reduces moisture migration between the food product and the environment.

As used herein, the term “lipid” refers to a broad group of naturally occurring molecules which includes fats (hydrogenated and non-hydrogenated), waxes, sterols, monoglycerides, diglycerides, and phospholipids. The lipid is any of a group of substances that in general are soluble in or miscible with ether, chloroform, or other organic solvents for fats and oils but are generally insoluble in water. Lipids can be classified as simple lipids, compound lipids, or derived lipids. Simple lipids include, but are not limited to, esters of fatty acids with alcohols. Fats and oils are esters of fatty acids with glycerol, and waxes are esters of fatty acids with alcohols other than glycerol. Compound lipids include, but are not limited to, phospholipids, cerebrosides or glycolipids, and others, such as sphingolipids. Derived lipids include, but are not limited to, substances derived from natural lipids (simple or compound) and include fatty acids, fatty alcohols and sterols, hydrocarbons and emulsifiers (artificially derived, surface active lipids).

As used herein, the term “probiotic micro-organism” refers to bacteria or other micro-organism, including those in a dormant state, that are capable of promoting human or animal, such as a companion animal, health by preserving and/or promoting the natural microflora in the gastrointestinal tract of the host human or animal and reinforcing the normal controls on aberrant immune responses. Probiotic micro-organism can include constituents of probiotic micro-organism such as, for example, proteins, carbohydrates or purified fractions of bacterial ferments.

As used herein, the term “solid fat index” (SFI) refers to the measure of the percentage of fat in solid phase to total fat (the remainder being in liquid phase) across a temperature gradient.

As used herein, the term “water activity” (A_{w}), refers to the vapor pressure of water in a sample, such as a food product sample, divided by the vapor pressure of pure water at the same temperature and generally refers to the amount of free water available to participate in chemical reactions. Water activity is often times represented by the mathematical equation A_{w}=p/p₀, where p is the vapor pressure of water in the sample and p₀ is the vapor pressure of pure water at the same temperature.

As used herein, the term “water vapor transmission rate” (WVTR) refers to the measure of the passage of water vapor through a substance per unit time and area.

Food Product:

The food product comprises a core. In an embodiment, the food product comprises a core and a layer. In such an embodiment, the layer is a moisture migration reduction layer on an external surface of the core and reduces, for example, moisture migration between the food product and the environment. In an embodiment, the food product comprises a core and at least two layers. In such an embodiment, one of the layers is a moisture migration reduction layer and is located in any of a variety of locations in the food product such as exemplified above. In an embodiment, the food product comprises from about 0.1, 1, 5, 10, or 25% to about 40, 50, 60, or 75% of the moisture migration reduction layer, by weight of the food product. In an embodiment, the food product comprises from about 25, 40, 50 or 60% to about 75, 90, 95 or 99.9% of the core, by weight of the food product. In an embodiment, the food product has a water activity of less than about 0.4. In an embodiment, the food product has a water activity of from about 0.05, 0.1 or 0.15 to about 0.2, 0.3 or 0.4. In an embodiment, the food product comprising a moisture migration reduction layer as described herein has a water activity of less than or equal to about 0.4 after 4 weeks at 39° C. and 97% relative humidity. In an embodiment, the food product comprising a moisture migration reduction layer has a water activity gain of less than about 50, 60, 70, 80 or 90% after 4 weeks at 39° C. and 97% relative humidity when compared with a food product without a moisture migration reduction layer. In an embodiment, the food product comprising the moisture migration reduction layer described herein has a loss in the viability of a probiotic micro-organism of less than or equal to three logs of an initial viability of the probiotic micro-organism following 4 weeks at 38° C. and 50% relative humidity.

Core:

The food product comprises a core which is the base nutritional matrix of food product ingredients of the food product. For example, a core that is intended for consumption by an animal, such as a companion animal, is an extruded kibble. As another example, a core that is intended for consumption by a human is a dried ready-to-eat cereal in the in shape of a puffed crisp. In an embodiment, the core comprises a macronutrient selected from the group consisting of a protein source, a fat source, a carbohydrate source and combinations thereof. Non-limiting examples of a core comprise, on a dry matter basis, from about 1, 5 or 10% to about 25, 35, 50 or 90% of a protein source, from about 0.5, 1, 5 or 10% to about 20, 25, 30 or 40% of a fat source, from about 1, 5, or 10% to about 25, 35, 50, 60 or 70% of a carbohydrate source, and combinations thereof, all by weight of the core. Non-limiting examples of a protein source include chicken, chicken meal, chicken-by-product meal, lamb, lamb meal, turkey, turkey meal, beef, beef by-product, viscera, fish meal, enterals, kangaroo, white fish, venison, soybean meal, soy protein isolate, soy protein concentrate, corn gluten meal, corn protein concentrate, distillers dried grains, distillers dried grains solubles, wheat, rice, milk proteins, and combinations thereof. Non-limiting examples of a fat source include poultry fat, chicken fat, turkey fat, pork fat, lard, tallow, beef fat, vegetable oils, corn oil, soy oil, cottonseed oil, palm oil, palm kernel oil, linseed oil, canola oil, rapeseed oil, fish oil, menhaden oil, anchovy oil, and combinations thereof. Non-limiting examples of a carbohydrate source include cereals, grains, corn, wheat, rice, oats, corn grits, sorghum, grain sorghum/milo, wheat bran, oat bran, amaranth, durum, semolina and combinations thereof. The core can comprise additional food product ingredients as desired by one of ordinary skill in the art such as, for example, a dietary fiber source, a starch source, an active ingredient and combinations thereof.

Moisture Migration Reduction Layer:

A food product comprises a moisture migration reduction layer. The moisture migration reduction layer comprises a high melting point lipid, a metal oxide, and an active ingredient. Each component of the moisture migration reduction layer will be discussed in more detail below. The active ingredient is incorporated into the moisture migration reduction layer to reduce degradation of the active ingredient and to attenuate a loss in the viability of the active ingredient. By incorporating the active ingredient into the moisture migration reduction layer, the active ingredient is surrounded by a stable environment (i.e., the moisture migration reduction layer) which is more resistant to degradation, for example, in a high temperature environment. Without being bound by theory, it is believed that incorporating the active ingredient into the moisture migration reduction layer will protect the active ingredient from moisture from the environment, from the core, and/or from a supplemental food product ingredient layer(s). In an embodiment, the Solid Fat Index of the moisture migration reduction layer is greater than or equal to about 70% at 22° C. In an embodiment, the Solid Fat Index of the moisture migration reduction layer is greater than or equal to about 20% at 45° C. In an embodiment, the ratio of the high melting point lipid to metal oxide is from about 4:1, 5:1, 10:1, 13:1 or 15:1 to about 20:1, 25:1, 40:1 or 50:1 by weight of the high melting point lipid and metal oxide. In an embodiment, the water vapor transmission rate of the moisture migration reduction layer is less than or equal to about 60 g/m²/day at 45° C. and 57.7% relative humidity.

It should be noted that an active ingredient may be located in the core of the food product, in a supplemental food product ingredient layer between the core of the food product and the moisture migration reduction layer, between the core of the food product and a layer comprising a high melting point lipid and a metal oxide, and combinations thereof. For example, in an embodiment a food product comprises a core of an extruded kibble comprising an active ingredient and a moisture migration reduction layer. In such an example, the active ingredient of the core may be the same as or different than the active ingredient of the moisture migration reduction layer. In another example, the food product comprises a core of an extruded kibble comprising an active ingredient and a layer of a high melting point lipid and metal oxide applied to the surface of the core. In an example, the food product comprises a core of an extruded kibble and two layers in which one layer is a moisture migration reduction layer and the second layer is a supplemental food product ingredient layer comprising an active ingredient. In such an example, the supplemental food product ingredient layer is between the core and the moisture migration reduction layer. In such an example, the active ingredient of the supplemental food product ingredient layer may be the same as or different than the active ingredient of the moisture migration reduction layer. In an example, the food product comprises a core and two layers in which one layer is a supplemental food product ingredient layer comprising an active ingredient and the second layer comprises a high melting point lipid and a metal oxide. In such an example the supplemental active ingredient layer is between the core and the layer comprising the high melting point lipid and the metal oxide. In an embodiment, the core of the food product may be coated, dusted or dry-mixed with an active ingredient or a supplemental food product ingredient layer comprising an active ingredient prior to the application of the layer of high melting point lipid and metal oxide or a moisture migration reduction layer.

The moisture migration reduction layer comprises a high melting point lipid. In an embodiment, the moisture migration reduction layer comprises a combination of high melting point lipids. In an embodiment, the moisture migration reduction layer comprises a combination of a high melting point lipid and a low melting point lipid. In such an embodiment, the solid fat index of the combination of the high melting point lipid and the low melting point lipid in the moisture migration reduction layer is greater than or equal to about 20% at 45° C. Non-limiting examples of low melting point lipids include palm kernel oil, hydrogenated soy oil and cocoa butter.

It has been found that the use of a high melting point lipid in the moisture migration reduction layer reduces moisture migration in situations such as, for example, when the food product is exposed to a stressful storage or transportation environment. A high melting point lipid requires a higher temperature to be reached before the lipid will begin to transition from a solid phase to a liquid phase. The use of a high melting point lipid, therefore, provides relatively greater heat stability to the moisture migration reduction layer and will reduce moisture migration into, out of and/or within the moisture migration reduction layer. If only a low melting point lipid is utilized in the moisture migration reduction layer, the lipid will more readily transition from a solid phase to a liquid phase in a high temperature environment allowing for an increase in moisture migration into, out of and/or within the moisture migration reduction layer and/or the food product. Moisture migration into the moisture migration reduction layer comprising an active ingredient results in the degradation of the active ingredient in the moisture migration reduction layer. In the event the active ingredient is a probiotic micro-organism, moisture migration into the moisture migration reduction layer results in a decrease in viability of the probiotic micro-organism.

As used herein, the term “high melting point lipid” refers to lipids having a melting point temperature above about 45°, 60°, 70°, 80°, 90°, or 100° C. Non-limiting examples of high melting point lipids include long chain fatty acids, their monoglycerides, diglycerides, and triglycerides, their alkaline metal salts, and other derivatives thereof, fatty alcohol (wax), paraffin, carnauba wax, hydrogenated oils (e.g, hydrogenated caster oil) and sucrose polyesters. In an embodiment, the high melting point lipid comprises long chain fatty acids comprising at least about 12, 18, 24 or 36 carbon atoms. In an embodiment, the high melting point lipid comprises long chain fatty acids comprising from about 12 or 18 to about 24 or 36 carbon atoms. In an embodiment, the high melting point lipid comprises saturated long chain fatty acids. Non-limiting examples of saturated long chain fatty acids include palmitic acid, stearic acid, arachidic acid, behenic acid, lignoceric acid, their derivatives, including, for example, glyceryl monostearate, glycerol distearate, glycerol tristearate, calcium stearate, magnesium stearate, high melting sucrose polyesters, high melting fatty alcohols, high melting waxes, high melting phospholipids, and combinations thereof. The moisture migration reduction layer comprises at least about 50%, 60%, 70%, 75%, 80%, 85%, 90%, or 95% of a high melting point lipid, by weight of the moisture migration reduction layer. The moisture migration reduction layer comprises from about 50%, 60%, 65%, 70%, or 75% to about 80%, 85%, 90%, or 95% of a high melting point lipid, by weight of the moisture migration reduction layer.

The moisture migration reduction layer comprises a metal oxide. It has been found that the use of a metal oxide enhances the high melting point lipid in reducing moisture migration from about 2, 3, 4, 5 or 6 to about 7, 8, 10 or 12 fold over the use of a high melting point lipid alone. The metal oxide is an inorganic material that is insoluble in or only dispersible in a lipid. As used herein, the term “dispersible” refers to particles or droplets of a substance being referred to, such as, for example, a metal oxide, distributed through another system, such as, for example, a lipid. In an embodiment, the metal oxide is GRAS (Generally Recognized As Safe) certified by the Food and Drug Administration or can be readily certified as GRAS. Non-limiting examples of metal oxides include calcium oxide, magnesium oxide, silicon oxide, silicone dioxide, titanium oxide, titanium dioxide, and zinc oxide. The moisture migration reduction layer comprises from about 0.5%, 1%, 2%, 3%, or 5% to about 7%, 8%, 9%, 10%, 15%, 20% or 25% of a metal oxide, by weight of the moisture migration reduction layer. The metal oxide ranges in particle size from about 0.100, 0.105, 0.110, 0.115, 0.120 or 0.150 microns to about 0.250, 0.275, 0.300 or 0.500 microns. In an embodiment, the metal oxide is in the form of a powder. In an embodiment, the metal oxide is in the form of a slurry. Non-limiting examples of slurries are described hereinbelow. In either the powder form or slurry form, the metal oxide can be surface treated to change the surface polarity of the metal oxide from polar to non-polar. Without being bound by theory, it is believed that changing the surface polarity of the metal oxide from polar to non-polar facilitates the dispersion of the metal oxide into the high melting point lipid base of the moisture migration reduction layer.

The moisture migration reduction layer comprises an active ingredient. It has been found that incorporating the active ingredient into the moisture migration reduction layer provides stability to the active ingredient and attenuates a loss in the viability of the active ingredient. By incorporating the active ingredient into the moisture migration reduction layer, the active ingredient is sheltered from the stresses encountered during manufacturing of a food product such as, for example, during an extrusion process. Additionally, by incorporating the active ingredient into a moisture migration reduction layer comprising a high melting point lipid the active ingredient is be sheltered from the stresses encountered during storage and transportation of the food product, such as, for example, increased temperatures and humidity in the environment. It should be noted that alternate locations of the active ingredient have been exemplified as above, and without being bound by theory, it is believed that the alternate locations of the active ingredient will also provide stability to the active ingredient as the active ingredient will be shielded from stress such as, for example, environmental stress, through the use of a layer comprising a high melting point lipid and a metal oxide. The moisture migration reduction layer comprises from about 0.5%, 1%, 2%, 3%, or 5% to about 6%, 10%, 15%, 20%, 30% or 40% of the active ingredient, by weight of the moisture migration reduction layer.

Non-limiting examples of an active ingredient include minerals, vitamins, amino acids, carotenoids, antioxidants, probiotic micro-organisms, botanical extracts, omage-3 fatty acids, and combinations thereof. Non-limiting examples of minerals include sodium selenite, monosodium phosphate, calcium carbonate, potassium chloride, ferrous sulfate, manganese sulfate, copper sulfate, potassium iodide, and cobalt carbonate. Non-limiting examples of vitamins include choline chloride, vitamin E supplement, ascorbic acid, vitamin A acetate, calcium pantothenate, pantothenic acid, biotin, thiamine mononitrate (source of vitamin B 1), vitamin B12 supplement, niacin, riboflavin supplement (source of vitamin B2), inositol, pyridoxine hydrochloride (source of vitamin B6), vitamin D3 supplement, folic acid, and vitamin C. Non-limiting examples of animo acids include 1-tryptophan, taurine, histidine, carnosine, alanine, cysteine, arginine, methionine, tryptophan, lysine, asparagine, aspartic acid, phenylalanine, valine, threonine, isoleucine, leucine, glycine, glutamine, tyrosine, homocysteine, ornithine, citruline, glutamic acid, proline, and serine. Non-limiting examples of carotenoids include lutein, astaxanthin, zeaxanthin, bixin, lycopene, and beta-carotene. Non-limiting examples of antioxidants include tocopherols (vitamin E), vitamin C, vitamin A, carotenoids, selenium and co-enzyme Q10. Non-limiting examples of probiotic micro-organisms include yeasts such as Saccharomyces, Debaromyces, Candida, Pichia and Torulopsis, molds such as Aspergillus, Rhizopus, Mucor, and Pencillium and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus, and Lactobacillus. The probiotic micro-organism may be provided in powdered, dry form, in spore form, or encapsulated. In an embodiment in which the active ingredient is a probiotic micro-organism, the moisture migration reduction layer comprises from about 10⁴ or 10⁶ to about 10⁸, 10¹¹, 10¹², 10¹⁴ or 10¹⁶ cells of the probiotic micro-organism per gram of the food product.

In an embodiment, the moisture migration reduction layer comprises a protein source. In an embodiment, the moisture migration reduction layer comprises from about 0.1% to about 50% of a protein source. In an embodiment, the moisture migration reduction layer comprises from about 0.1%, 0.5%, 1%, 5%, 10%, 15% or 20% to about 30%, 35%, 40%, 45%, 49% or 50% of a protein source. Non-limiting examples of a protein source include chicken, chicken meal, chicken-by-product meal, lamb, lamb meal, turkey, turkey meal, beef, beef by-product, viscera, fish meal, enterals, kangaroo, white fish, venison, soybean meal, soy protein isolate, soy protein concentrate, corn gluten meal, corn protein concentrate, distillers dried grains, distillers dried grains solubles, wheat, rice, milk proteins and combinations thereof.

In an embodiment, the moisture migration reduction layer comprises a clay source. Clay generally is a naturally occurring material composed primarily of fine-grained materials, which show plasticity through a variable range of water content, and which can be hardened when dried and/or fired. Clay deposits are mostly composed of clay minerals and variable amounts of water trapped in the mineral structure by polar attraction. Clay minerals are hydrous aluminum phyllosilicates, sometimes with variable amounts of iron, magnesium, alkali metals, alkaline earths, and other cations. Clay minerals include, but are not limited to, the following groups: kaolin group (which includes, for example, the minerals kaolinite, dickite, halloysite and nacrite), smectite group (which includes, for example, dioctahedral smectites such as montmorillonite and nontronite and trioctahedral smectites), illite group (which includes, for example, the clay-micas), chlorite group and 2:1 clay types such as, for example, sepiolite and attapulgite. Additional examples of clay sources include, but are not limited to, laponite clay, diatomite clay, and zeolites. In an embodiment, the clay source comprises a silicone dioxide content from about 45% to about 75% by weight of the clay source. In an embodiment, the moisture migration reduction layer comprises from about 0.5%, 1%, 2%, 3%, or 5% to about 7%, 8%, 9%, 10%, 15%, 20% or 25% of a clay source, by weight of the moisture migration reduction layer.

In an embodiment, the moisture migration reduction layer comprises an emulsifier. Examples of an emulsifier include, but are not limited to, lecithin, organic acid esters (e.g., citric acid esters), monoglycerides, diglycerides, polysorbates, glycol esters, sorbitan fatty acids, polyoxyethylene sorbitol esters, and combinations thereof. Without being bound by theory, it is believed that the emulsifier facilitates dispersion of an active ingredient into the moisture migration reduction layer. For example, in an embodiment in which the active ingredient is a vitamin or mineral, an emulsifier may be included in the moisture migration reduction layer to facilitate dispersion of the vitamin or mineral into the moisture migration reduction layer.

In an embodiment, the moisture migration reduction layer comprises a gel forming source. Examples of a gel forming source include, but are not limited to, xanthan gum, cellulose, cellulose derivatives, guar gum, carrageenan, pectin, milk proteins, milk peptides, caseins, gelatins, and combinations thereof.

Application of the Moisture Migration Reduction Layer:

The moisture migration reduction layer is applied to the surface of the core and/or another layer, if present, of the food product by any suitable manner. Non-limiting examples of application techniques include spraying, dipping, pan coating, enrobing, brushing, deposition, extrusion, and the use of a fluidized bed. In an embodiment, the moisture migration reduction layer is applied to the desired surface of the food product by immersing the food product, or the surface thereof to be coated, into a melted or molten moisture migration reduction layer composition, removing the food product, and allowing the food product and moisture migration reduction layer composition to cool. In an embodiment, the melted or molten moisture migration reduction layer is applied by brushing the melted or molten moisture migration reduction layer composition to the desired surface(s) of the food product. In an embodiment, the moisture migration reduction layer is applied by spraying the moisture migration reduction layer composition onto the desired surface(s) of the food product. Spraying can be accomplished in any suitable manner such as, for example, by atomized spray, air-brushing, fluidized bed, and rotary coater.

The thickness of the moisture migration reduction layer can vary depending upon the nature of the core and other layer(s) if present, the environmental conditions to which the food product will be exposed, the choice of high melting point lipid, metal oxide, and active ingredient utilized in the formulation of the moisture migration reduction layer, and combinations thereof. The thickness of the moisture migration reduction layer can also vary as a result of any limitations imposed by the method selected for application of the moisture migration reduction layer to the food product. In an embodiment, the moisture migration reduction layer is from about 0.02, 0.05, 0.1, 0.5, or 0.75 mm to about 1, 3, 5 or 10 mm in thickness. It should be realized that the thickness of a supplemental food product ingredient layer can vary and the thickness can range from about 0.02, 0.05, 0.1, 0.5 or 0.75 mm to about 1, 3, 5 or 10 mm.

### Examples

### Example 1

### Water Vapor Transmission Rate and Solid Fat Index

Lipids are evaluated for their thermal properties including water vapor transmission rate and solid fat index. The water vapor transmission rate is measured gravimetrically utilizing a cup method based on ASTM E 96 Standard Test Method. An amount of 100 grams of the lipid to be evaluated is melted and evenly spread onto a lipid-imbibed W40 filter paper film support (imbibing is performed as described by Kester, J J, Fennema, O, J. Am. Oil Chemists' Society, 66:8, 1989) using a glass stirring rod warmed to 100° C. in an oven. The melted lipid solidifies to form a film and has a thickness from 0.10 to 0.50 mm as measured by a digital micrometer. The lipid film and filter paper are placed onto a cup containing 25 mL of a saturated NaBr salt solution (representing 57.7% relative humidity). The lipid film and filter paper are situated such that the lipid film covers the opening of the cup. The combination of the lipid film, filter paper and cup are placed into a desiccator controlled for one of three temperatures (22° C., 35° C., or 45° C.) and relative humidity. The relative humidity of the desiccator is 15% and the relative humidity inside the cup is 57.7%. Water loss from the cup is obtained by weighing the cup every 24 hours for 7 days. The slope of the water loss as a function of incubation time is utilized to calculate the water vapor transmission rate. The solid fat index is measured using a Differential Scanning Calorimeter (available from TA Instruments, DSC 2920 Modulated DSC with Cooling System) and is measured using the procedure as described by Cassel, RB (TA Instruments, Inc., TA 290) and Bentz & Breidenbach (J. Am. Oil Chemists' Society, 46: 60-63; 1969). The percent of lipid melted (p, where p=% area) at the temperature of interest is calculated by integrating the area of the corresponding peak. The Differential Scanning Calorimeter has a software program which converts the integrated area into a percent area (p). The solid fat index is obtained by subtracting p from 100.

Table 1 provides the melting point, water vapor transmission rate and solid fat index of six lipid samples evaluated at 22°, 35° and 45° C.

TABLE 1

| | Melting Point | WVTR (g/m²/day) | | | Solid Fat Index (%) | | |
|---|---|---|---|---|---|---|---|
| Lipid | (° C.) | 22° C. | 35° C. | 45° C. | 22° C. | 35° C. | 45° C. |
| Palm Kernel Oil | 34 | 15.7 | 201.5 | 622.5 | 94.5 | 5.1 | 0 |
| Cocoa Butter | 35 | 49.98 | 192.3 | 212.0 | 100 | 23.9 | 0.1 |
| Paraffin Wax70 | 60 | 5.4 | 16.4 | 33.0 | 100 | 98.8 | 89.7 |
| Beeswax | 63 | 9.3 | 28.7 | 53.9 | 100 | 97.4 | 87.6 |
| Stearic Acid | 71 | 11.8 | 23.1 | 36.7 | 100 | 100 | 100 |
| Olestra | 38-71 | 11.6 | 29.3 | 60.5 | 72.1 | 48.4 | 31.5 |

### Example 2

### Effect of Titanium Dioxide on Water Vapor Transmission Rate

The ability of titanium dioxide to enhance moisture migration reduction when in combination with a high melting point lipid is evaluated by checking the water vapor transmission rate of a high melting point lipid-based film comprising titanium dioxide. The water vapor transmission rate is measured utilizing ASTM E 96 Standard Test Method. A high melting point lipid-based film is obtained by combining and melting beeswax (60% by weight of the lipid-based film) and paraffin70 (40% by weight of the lipid-based film). The desired weight percent of titanium dioxide is slowly mixed into the melted high melting point lipid combination. The weight percent of titanium dioxide in a high melting point lipid-based film is as follows: Control treatment—a high melting point lipid-based film comprising a combination of beeswax and paraffin70; Test treatment 1—10% titanium dioxide (FAS70USI), by weight of the high melting point lipid-based film; test treatment 2—3.8% titanium dioxide (TNP50T7), by weight of the high melting point lipid-based film; test treatment 3—1.8% titanium dioxide (CM3K25VM-A L) by weight of the high melting point lipid-based film. The titanium dioxide is in the form of a slurry as provided by Kobo Products, Inc. Table 2 provides the description of the three slurries, the percent of titanium dioxide in each slurry and the mean particle size of the titanium dioxide in each slurry.

TABLE 2

| | | | TiO₂ mean |
|---|---|---|---|
| Slurry Catalog | | Percent | particle size |
| Code^{a} | Description | TiO₂ | (nm) |
| FAS70USI | TiO₂, cyclopentasiloxine, | 65.5 | 300 |
| | PEG/PPG-18/18 dimethicone | | |
| | and triethoxycaprylylsilane | | |
| CM3K25VM-AL | Cyclopentasiloxine, TiO₂, | 18.5 | 115 |
| | alumina, PEG-10 | | |
| | dimethicone and methicone | | |
| TNP50T7 | C12-15 alkyl benzoate, TiO₂, | 37.5 | 130 |
| | cyclopentasiloxine, alumina, | | |
| | polyhydroxystearic acid | | |
| | and methicone | | |

^{a}Catalog Codes as available from Kobo Products, Inc.

The combination of the high melting point lipids and titanium dioxide is spread onto a 7.1 mesh/mm² nylon mesh disc using a bar applicator heated to 120° C. The melted high melting point lipid and titanium dioxide combination solidifies to form a film and has a thickness from 0.10 to 0.50 mm. To measure the thickness, the total lipid volume (cm³)is determined first by dividing the lipid weight by the lipid density, then determining the lipid volume above the nylon mesh disc (i.e., the high melting point lipid-based film layer exposed to the higher percent relative humidity) by subtracting the lipid volume in the nylon mesh (0.0238 cm³) from the total lipid volume, and lastly by dividing the lipid volume above the nylon mesh by the mesh area (25 cm²). The titanium dioxide and high melting point lipid-based film and disc are placed onto a cup containing 25 mL of a saturated NaBr salt solution representing 57.7% relative humidity. The titanium dioxide and high melting point lipid-based film and disc are situated such that the titanium dioxide and high melting point lipid-based film covers the opening of the cup. The titanium dioxide and high melting point lipid-based film, disc and cup are placed into a chamber controlled for 24 hours at 45° C. and the relative humidity of the chamber is 0% and the relative humidity inside the cup is 57.7%. The weight loss from the cup is measured to calculate the water vapor transmission rate. Table 3 provides the film thickness normalized water vapor transmission rate and the increase in the enhancement of the high melting point lipid-based film when combined with titanium dioxide to reduce moisture migration.

TABLE 3

| | | | | TiO₂ enhancing |
|---|---|---|---|---|
| | | | | effect on lipid- |
| | TiO₂ Level | | Thickness | based film to |
| | (% by weight of | | Normalized | reduce moisture |
| Treatment | the lipid film) | Thickness (m) | WVTR (g/s/m)^{a} | migration |
| Control | 0 | 1.01E−04 | 2.56E−07 | — |
| Test Treatment 1 | 10 | 8.57E−05 | 2.14E−08 | 12X |
| Test Treatment 2 | 3.8 | 8.93E−05 | 8.18E−08 | 3.1X |
| Test Treatment 3 | 1.8 | 1.21E−04 | 3.92E−08 | 6.5X |

${ }^{a} The thickness normalized WVTR ( g \text{/} s \text{/} m ) = \frac{water loss ( g ) \cdot film thickness}{second ( s ) \cdot {m}^{2}}$

### Example 3

### Effect of Titanium Dioxide on Water Vapor Transmission Rate as Function of Concentration

The ability of titanium dioxide to enhance moisture migration reduction when in combination with a high melting point lipid is evaluated as a function of the concentration of titanium dioxide in a high melting point lipid-based film. The water vapor transmission rate is measured utilizing ASTM E 96 Standard Test Method. A high melting point lipid-based film is obtained by melting paraffin70 and slowly mixing titanium dioxide into the paraffin70. The titanium dioxide is in the form of a slurry (catalog code M060AFDC-PW, by Kobo Products, Inc.). Five high melting point lipid-based films are evaluated: control treatment is a high melting point lipid-based film comprising paraffin70; test treatment 1—2.5% titanium dioxide by weight of the high melting point lipid-based film; test treatment 2—5% titanium dioxide by weight of the high melting point lipid-based film; test treatment 3—7.5% titanium dioxide by weight of the high melting point lipid-based film; and test treatment 4—10% titanium dioxide by weight of the high melting point lipid-based film.

The combination of the paraffin 70 and the titanium dioxide are spread onto a 7.1 mesh/mm² nylon mesh disc using a bar applicator heated to 120° C. The melted high melting point lipid and titanium dioxide solidifies to form a film and has a thickness from 0.10 to 0.50 mm. To measure the thickness, the total lipid volume (cm³)is determined first by dividing the lipid weight by the lipid density, then determining the lipid volume above the nylon mesh disc (i.e., the high melting point lipid-based film layer exposed to the higher percent relative humidity) by subtracting the lipid volume in the nylon mesh (0.0238 cm³) from the total lipid volume, and lastly by dividing the lipid volume above the nylon mesh by the mesh area (25 cm²). The titanium dioxide and high melting point lipid-based film and disc are placed onto a cup containing 25 mL of a saturated NaBr salt solution representing 57.7% relative humidity. The titanium dioxide and high melting point lipid-based film and disc are situated such that the titanium dioxide and high melting point lipid-based film covers the opening of the cup. The titanium dioxide and high melting point lipid-based film, disc and cup are placed into a chamber controlled for 42 hours at 45° C. and the relative humidity of the chamber is 0% and the relative humidity inside the cup is 57.7%. The weight loss from the cup is measured to calculate the water vapor transmission rate. Table 4 provides the film thickness normalized water vapor transmission rate as a function of the concentration of the titanium dioxide.

TABLE 4

| | | Thickness Normalized WVTR |
|---|---|---|
| Treatment | Ratio of Paraffin70:TiO₂ | (g/s/m)^{a} |
| Control | 100:0 | 2.56E−07 |
| 2.5% TiO₂ | 40:1 | 4.48E−08 |
| 5% TiO₂ | 20:1 | 5.32E−08 |
| 7.5% TiO₂ | 13:1 | 5.26E−08 |
| 10% TiO₂ | 10:1 | 1.21E−08 |

${ }^{a} The thickness normalized WVTR ( g \text{/} s \text{/} m ) = \\ \frac{water loss ( g ) \cdot film thickness}{second ( s ) \cdot {m}^{2}}$

### Example 4

### Effect of Lipid-Based Layer on Water Activity Gain of a Food Product

A food product for a companion animal is prepared using standard mixing, conditioning, extrusion, and drying technology known in the pet food industry. The food product comprises an extruded kibble as the core. The extruded kibble core of the food product comprises the food product ingredients as listed in Table 5.

TABLE 5

| Ingredient | Weight Percent |
|---|---|
| Carbohydrate | 58.52 |
| Protein | 25.82 |
| Fat | 8.49 |
| Fiber | 4.01 |
| Minerals | 2.24 |
| Vitamins | 0.35 |
| Colorant | 0.29 |
| Amino Acids | 0.17 |
| Antioxidants | 0.11 |

The core is dried until the water activity is reduced to from 0. 1 to 0.2. The core is placed in a negative 20° C. freezer for 24 hours. A lipid-based layer is applied to the core for evaluation of water activity gain as follows: the control treatment is the food product without a lipid-based layer; and the test treatments comprise a lipid-based layer applied by dipping the frozen core into a melted lipid-based layer comprising as follows: test treatment 1—paraffin70; test treatment 2—paraffin70 and 10% titanium dioxide, by weight of the lipid-based layer; test treatment 3—palm kernel oil. The lipid-based layers of the food products solidify at standard room temperature and relative humidity. Following solidification of the lipid-based layers, each treatment is placed into a desiccator and equilibrated with saturated KSO₄ (at 97% relative humidity). The desiccators are placed into a 39° C. oven and water activity measurements are collected at time 0, 1 week, 2 weeks, 3 weeks and 4 weeks. Water activity is measured using a Rotronic Water Activity Meter with AwVC probe. To measure water activity, samples of each of the treatments are crushed into a powder using a mortar and pestle. The powder is poured into a cup and placed in the AwVC probe's sample holder. Water activity is measured by following the procedure outlined in the User Manual of the Rotronic Water Activity Meter. Table 6 provides the water activity gain observed in the food products over the four weeks.

TABLE 6

| | Treatment | | | | | |
|---|---|---|---|---|---|---|
| | Layer | Water Activity Gain | | | | |
| | Thickness | | 1 | 2 | 3 | 4 |
| Treatment | (mm) | Initial | Week | Weeks | Weeks | Weeks |
| Control | 0 | 0 | 0.633 | 0.642 | 0.791 | 0.801 |
| Paraffin70 | 2 | 0 | 0.027 | 0.045 | 0.153 | 0.164 |
| Paraffin70 + | 2.2 | 0 | 0 | 0 | 0.028 | 0.083 |
| TiO₂ | | | | | | |
| Palm | Not | 0 | 0.596 | 0.563 | 0.633 | 0.57 |
| Kernel Oil | measured | | | | | |

### Example 5

### Effect of Lipid-Based Film on the Viability of a Probiotic Micro-organism

Three lipid-based films are made by combining the components as follows: lipid-based film 1 comprises 60% beeswax and 40% paraffin70, each by weight of the lipid-based film; lipid-based film 2 comprises 54% beeswax, 36% paraffin70 and 10% titanium dioxide, each by weight of the lipid-based film; and lipid-based film 3 comprises Paramount B KLX. Each lipid-based film is melted and to each lipid-based film a probiotic micro-organism in the form of a freeze dried powder in an amount of 2.0±0.15 g per 100 g of the melted lipid-based film is added for a target dose of 5.95E+09 cfu/g and mixed for 1-2 minutes. The lipid-based films solidify in multiple individual wells of a tray and are placed in a controlled chamber at 38° C. and 50% relative humidity. Samples from each lipid-based film are taken at time 0, 1 week and 4 weeks. A sample is an individual solidified lipid-based film from an individual well. Each sample is prepared by aseptically weighing the sample into a sterile stomacher bag (available from Interscience Laboratories, Inc., Weymouth, Mass.) and recording the weight. The sample is diluted 10 fold by adding sterile Butterfield's Phosphate-Buffered Dilution Water (Bacteriological Analytical Manual, AOAC International 8^{th} Edition, 1998). The sample is allowed to soften for 15 minutes in a 37° C. incubator. The sample is then flattened and broken into smaller pieces and blended for two minutes. A series of 10 fold dilutions of the sample are created using 9.0 ml blanks of sterile Butterfield's Phosphate-Buffered Dilution Water. To begin the dilution, 1 ml of the blended sample is transferred into a 9 ml dilution blank containing Butterfield's Phosphate-Buffered Dilution Water (making a −2 dilution). Serial dilute the sample by transferring 1 ml from the −2 dilution into a different 9 ml dilution blank (making a −3 dilution). This step is repeated to create the series of dilutions. Each blank is vortexed prior to performing the next dilution. The sample is plated in duplicate by aseptically pipetting 0.1 ml of the −6, −7 and −8 dilutions onto room temperature Difco Lactobacilli MRS Agar (DeMan, Rogosa and Sharpe Agar) containing approximately 15-20 ml of the sterile MRS agar. Samples are spread evenly over the entire surface of the plate, using a sterile spreader. The plates are inverted and placed into a 7 liter anaerobic jar (Mitsubishi). An anaerobic indicator (Oxoid) is placed inside the anaerobic jar. Three AnaeroPack sachets are opened and one sachet is placed in one compartment of the anaerobic jar and two sachets are placed in the other compartment of the anaerobic jar. The lid of the anaerobic jar is placed on top of the anaerobic jar and a good seal is ensured. The anaerobic jar is placed in an incubator at 37° C.±2° C. for a 48 hour ±2 hour incubation period. After the incubation period, the plates are removed from the incubator and anaerobic jar and typical bacterial colonies are counted manually using a Quebec Colony Counter to magnify the colonies. The plates are enumerated in the range of 25-250 colonies. Once a raw count (number of colonies counted on the plate) is completed, the raw count is multiplied by the dilution and divided by the volume plated to obtain a CFU/gram of sample. Table 7 provides the viability of the probiotic micro-organism in the lipid-based layer over the four weeks.

TABLE 7

| | Probiotics Viability (cfu/g) | | |
|---|---|---|---|
| Treatment | Initial | 1 Week | 4 Weeks |
| Beeswax-Paraffin70 | 4.55E+09 | 1.15E+09 | 2.22E+07 |
| Beeswax-Paraffin70 + | 3.75E+09 | 3.02E+09 | 3.98E+08 |
| TiO₂ | | | |
| Paramount B KLX | 1.55E+10 | 6.36E+09 | 2.32E+05 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A food product comprising:
a. a core comprising a macronutrient selected from the group consisting of a first protein source, a fat source, a carbohydrate source, and combinations thereof, and
b. a moisture migration reduction layer, the moisture migration reduction layer comprising a high melting point lipid, a metal oxide, an active ingredient, and from about 0.1% to about 50% of a second protein source, by weight of the moisture migration reduction layer.

2. The food product of claim 1 wherein the moisture migration reduction layer has a thickness from about 0.02 mm to about 10 mm.

3. The food product of claim 1 wherein the active ingredient is selected from the group consisting of a mineral, a vitamin, an amino acid, a carotenoid, an antioxidant, a probiotic micro-organism, a botanical extract, an omega-3 fatty acid, and combinations thereof.

4. The food product of claim 1 wherein the first protein source and the second protein source are the same.

5. The food product of claim 1 wherein the metal oxide is selected from the group consisting of calcium oxide, magnesium oxide, silicon oxide, silicon dioxide, titanium oxide, titanium dioxide, zinc oxide and combinations thereof.

6. The food product of claim 1 wherein the food product further comprises a supplemental food product ingredient layer.

7. A food product comprising:
a. a core comprising a macronutrient selected from the group consisting of a protein source, a fat source, a carbohydrate source, and combinations thereof, and
b. a moisture migration reduction layer, the moisture migration reduction layer comprising a high melting point lipid, a metal oxide, and an active ingredient,
wherein a ratio of the high melting point lipid to the metal oxide is from about 4:1 to about 50:1.

8. The food product of claim 7 wherein the food product has a water activity of less than or equal to about 0.4 after four weeks at 39° C. and 97% relative humidity.

9. The food product of claim 7 wherein the food product has a water activity gain of less than about 50% after four weeks at 39° C. and 97% relative humidity.

10. The food product of claim 7 wherein the moisture migration reduction layer has a thickness from about 0.02 mm to about 10 mm.

11. The food product of claim 7 wherein the active ingredient is selected from the group consisting of a mineral, a vitamin, an amino acid, a carotenoid, an antioxidant, a probiotic micro-organism, a botanical extract, an omega-3 fatty acid, and combinations thereof.

12. The food product of claim 11 wherein the active ingredient is a probiotic micro-organism.

13. The food product of claim 12 wherein the moisture migration reduction layer is effective at attenuating a loss in viability of the probiotic micro-organism to less than or equal to three logs of an initial viability of the probiotic micro-organism following 4 weeks at 38° C. and 50% relative humidity.

14. The food product of claim 7 wherein the metal oxide is selected from the group consisting of calcium oxide, magnesium oxide, silicon oxide, silicon dioxide, titanium oxide, titanium dioxide, zinc oxide and combinations thereof.

15. The food product of claim 7 wherein the food product further comprises a supplemental food product ingredient layer.

16. A moisture migration reduction layer comprising a high melting point lipid, a metal oxide, and a probiotic micro-organism, wherein a ratio of the high melting point lipid to the metal oxide is from about 4:1 to about 50:1.

17. The moisture migration reduction layer of claim 16 wherein the moisture migration reduction layer comprises a solid fat index of greater than or equal to about 70% at 22° C.

18. The moisture migration reduction layer of claim 16 wherein the moisture migration reduction layer comprises a solid fat index of greater than or equal to about 20% at 45° C.

19. The moisture migration reduction layer of claim 16 further comprising from about 0.1% to about 50% of a protein source, by weight of the moisture migration reduction layer.

20. The moisture migration reduction layer of claim 16 wherein the water vapor transmission rate of the moisture migration reduction layer is less than or equal to about 60 g/m²/day at 45° C. and 57.7% relative humidity.
